(19) United States
(12) Patent Application Publication
(10) Pub. No.: US 2006/0179623 A1
(43) Pub. Date: Aug. 17, 2006

(54) Degradable urn

(76) Inventor: Hewitt Robinson, Indianapolis, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/203,920

(22) Filed: Aug. 15, 2005

Related U.S. Application Data
(60) Provisional application No. 60/652,472, filed on Feb. 11, 2005.

(51) Int. Cl. A61G 17/00

(52) U.S. Cl. 27/1

(57) ABSTRACT

One embodiment of the present invention is an urn for holding the cremated remains of a deceased human or pet, the urn comprising a body portion and a lid portion. The body portion includes an opening and defines an inner cavity for placement of the remains. The body portion is relatively flat in shape. The lid portion is configured to cover the opening. Additionally, the body portion and the lid are composed of rock salt. The composition of the rock salt preferably allows the urn to float for a minimum of 1 minute upon placement on water and dissolve within several hours upon placement on water.

### CROSS REFERENCE TO RELATED APPLICATIONS

This application claims priority to provisional application Ser. No. 60/652,472, filed Feb. 11, 2005, which is hereby incorporated by reference in its entirety.

### FIELD OF THE INVENTION

The present invention relates generally to urns and more particularly to a floating degradable urn for human remains or for pet remains.

### BACKGROUND OF THE INVENTION

While the prior art discloses various means for burying the remains of humans and pets, there remain needs for an urn that is not met in the prior art. The urn should be degradable over time in an environmentally friendly, non-toxic manner. The urn should be usable to contain the ashes of the deceased for the bereaved user to be retained and displayed by the user in a place of honor for the period of time that the user desires. The urn should be aesthetically pleasing and provide memorialization of the human or pet in a dignified manner. The urn should float upon placement on water for an amount of time prior to degradation of the urn. The present invention is directed to meeting these needs, among others.

### SUMMARY OF THE INVENTION

The present invention includes an urn for holding the remains of a deceased human or pet.

According to one aspect of the invention, rock salt is carved with a lathe to produce an urn with a body portion and lid. The lid is configured to cover the top opening. The lid can be secured to the body using a non-toxic glue, such as Elmer's school glue.

According to another aspect of the invention, an urn for holding the cremated remains of a deceased human or pet comprises a body portion and a lid portion. The body portion includes an opening and defines an inner cavity for placement of the remains. The body portion is relatively flat in shape. The lid portion is configured to cover the opening. Additionally, the body portion and the lid are composed of rock salt. The composition of the rock salt preferably allows the urn to float for a minimum of 1 minute upon placement on water and dissolve within several hours upon placement on water.

According to a further aspect of the invention, an urn is formed of rock salt having the following properties by chemical analysis: 0.037% calcium, 0.001% iron, 0.015% magnesium, 99.09% salt, and 0.857% moisture. Additionally, the composition of the salt includes 39.17% sodium and 59.92% chloride. Preferably, the composition allows the urn to float for a minimum of 1 minute upon placement in water and allows the urn to dissolve within several hours upon placement in water.

According to yet another aspect of the invention, a method includes providing an urn for holding cremated remains and placing the urn on water. The urn is composed of rock salt and is relatively flat in shape. The urn is preferably configured to float upon placement on water for a minimum of 1 minute and dissolve within several hours after placement on water.

This product (Salt Rock or rock salt) is a natural mineral deposit found in various parts of the world. In its natural form, the rock salt can exhibit various colors due to the type of other mineral deposits that had geologically settled with it during its formation.

### BRIEF DESCRIPTION OF THE DRAWINGS

FIG. 1 is a front view of an urn according to one embodiment of the present invention.

FIG. 2 is a front view of an urn according to another embodiment of the present invention.

FIG. 3 is a cross sectional view of an urn according to the embodiment illustrated in FIG. 1.

FIG. 4 is a top view of an urn according to the embodiment illustrated in FIGS. 1 and 3.

FIG. 5 is a cross sectional view of an urn according to the embodiment illustrated in FIG. 2.

### DESCRIPTION OF THE ILLUSTRATED EMBODIMENTS

For the purposes of promoting an understanding of the principles of the invention, reference will now be made to the embodiments illustrated and specific language will be used to describe the same. It will nevertheless be understood that no limitation of the scope of the invention is thereby intended, such alterations, modifications, and further applications of the principles of the invention being contemplated as would normally occur to one skilled in the art to which the invention relates.

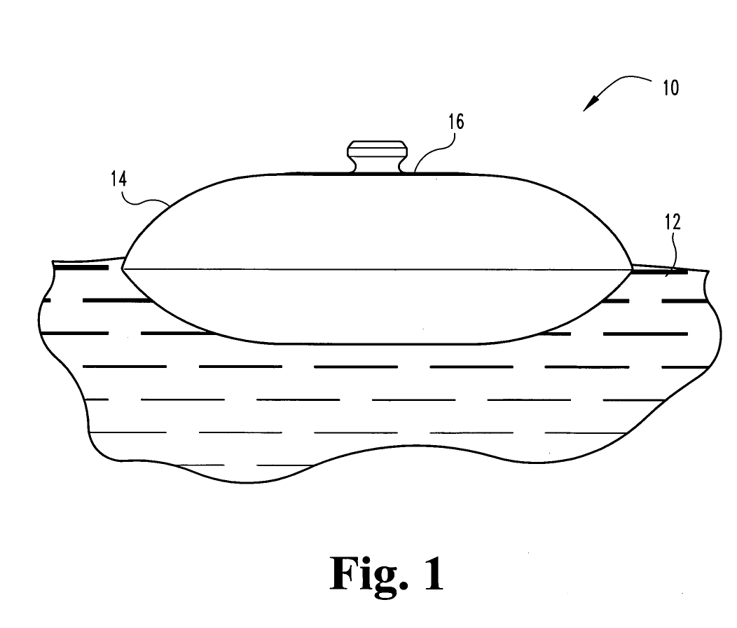

Referring to FIG. 1, there is illustrated therein an urn according to one aspect of the invention. Urn 10 includes a body 14 of an aesthetically pleasing outward configuration that is designed to hold the cremated remains of a human or pet. A lid 16 is positionable on the body 14 to cover a top opening in the body and close the urn. A non-toxic glue, such as Elmer's school glue, can be applied to secure the lid 16 to the body 14 and seal the urn. Additionally, the urn is configured to be placed on water 12, as illustrated in FIG. 1.

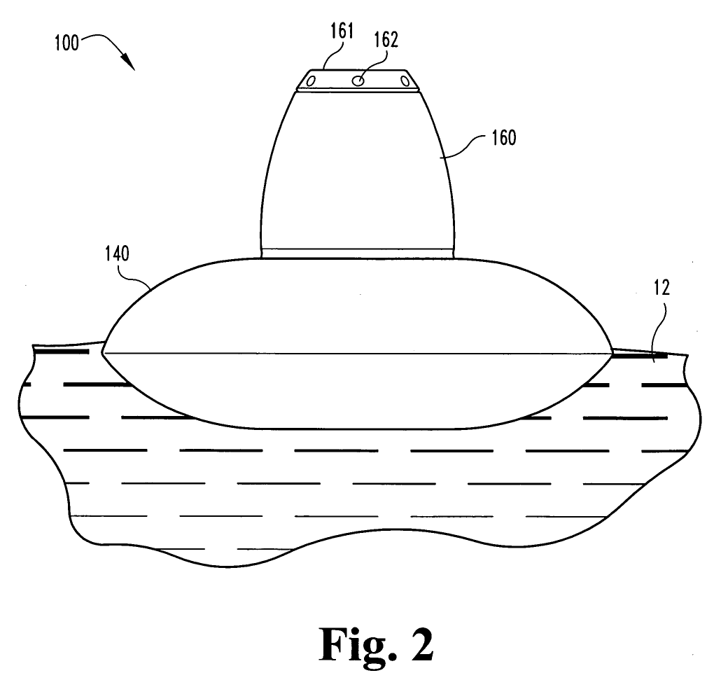

Referring to FIG. 2, there is illustrated therein an urn according to another aspect of the invention. Urn 100 includes a body 140 of an aesthetically pleasing outward configuration that is designed to hold the cremated remains of a human or pet. A lid 160 is positionable on the body 140 to cover a top opening in the body and close the urn. A non-toxic glue, such as Elmer's school glue, can be applied to secure the lid 160 to the body 140 and seal the urn. Additionally, the urn is configured to be placed on water 12, as illustrated in FIG. 2.

In a preferred form, bodies 14 and 140 and lids 16 and 160 are formed of rock salt which is obtained by mining natural rock salt and then forming it to the illustrated configuration by carving on a lathe.

In one specific embodiment of the invention, urns 10 and 100 are formed of rock salt having the following properties by chemical analysis:

| PARAMETER | VALUE |
|---|---|
| Calcium (Ca) | 0.037% |
| Iron (Fe) | 0.001% |
| Magnesium | 0.015% |
| Salt | 99.09% |
| Moisture | 0.857% |

Additionally, according to one specific embodiment of the invention, the salt in the urns has the following properties by chemical analysis:

| PARAMETER | VALUE |
|---|---|
| Sodium (Na) | 39.17% |
| Chloride | 59.92% |

The ornamentation on the body and lid portions of the urns can include varying and beautiful colors and configurations caused by the natural mineral deposits found in various parts of the world and which settled with the rock salt during its formation over time.

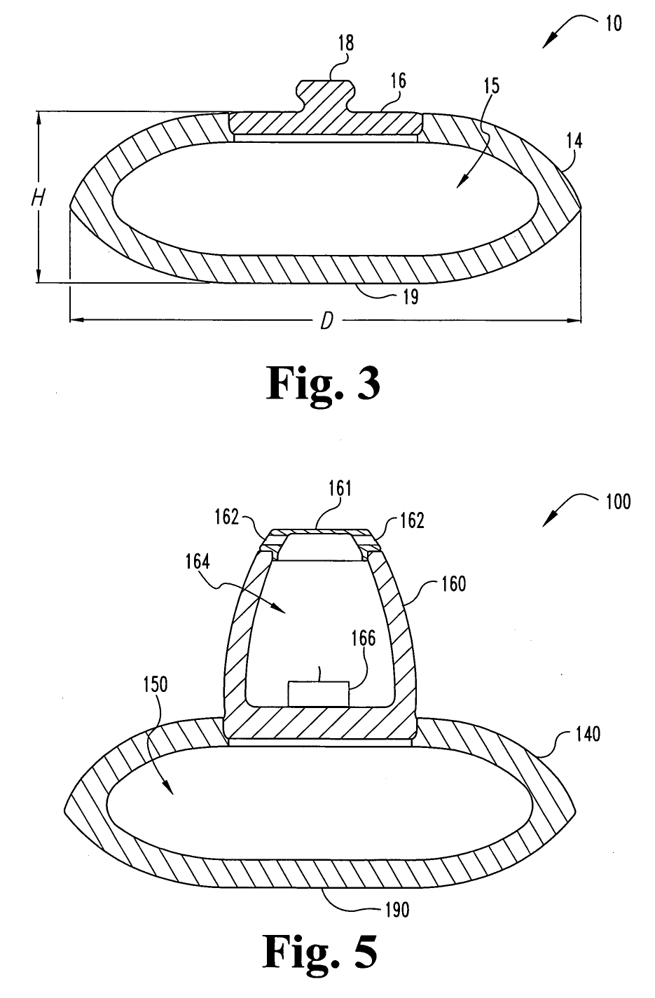

Referring to FIG. 3, a cross sectional view of the urn 10 is shown. The body 14 of the urn 10 defines a receptacle 15 sized to receive the cremated remains of a human or pet. Referring to FIG. 5, a cross sectional view of the urn 100 is shown. The body 140 of the urn 100 defines a receptacle 150 sized to receive the cremated remains of a human or pet. In a preferred embodiment, the receptacles 15 and 150 each have a volume of at least 220 cubic inches. Again referring to FIG. 3, the lid 16 includes a knob 18 to assist in removal and closure of the lid 16.

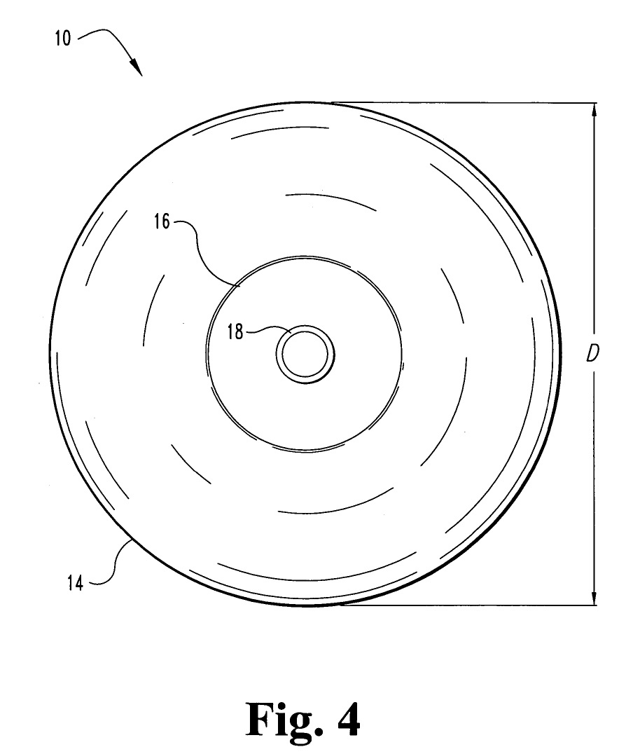

In a typical configuration, the urn 10 includes a height H and a maximum diameter D of the body 14. FIG. 4 is a top view of the urn 10, illustrating the generally circular shape of the urn with maximum diameter D. In a preferred embodiment, a ratio of the height H to diameter D is 0.4 or less. In a more preferred embodiment, a ratio of the height H to diameter D is 0.375 or less. In one embodiment, the height H of the urn 10 is approximately 4 inches and the other dimensions are scaled accordingly. The relatively flat shape of the urns, and more specifically the relatively flat shape of the body portions of the urns, encourages floating of the urns for a certain period of time, as will be discussed below. Moreover, urns 10 and 100 include flat bottom sections 19 and 190, respectively, which also encourage floating of the urns for a certain period of time.

Referring again to FIG. 5, lid 160 defines an inner cavity 164 sized to receive a memorial item, such as a candle 166. In certain embodiments, lid 160 has an opening, and a top lid 161 is configured to cover the opening in lid 160. Holes 162 allow for oxygen exchange and allow light from candle 166 to emit from the inner cavity 164.

Referring generally to FIGS. 1-5, a method of using the urns involves providing an urn with cremated remains, as described above, and placing the urn on water. The chemical composition of the rock salt comprising the urns allows the urns to float for a relatively short period of time and then dissolve within several hours upon placement on the water. In a preferred embodiment, the urns will float for a minimum of 1 minute. In a more preferred embodiment, the urns will float for a minimum of 2 minutes. In an even more preferred embodiment, the urns will float for a time period in the range of 2½ to 5 minutes. Additionally, in preferred embodiments, the urns will dissolve in the range of 1 to 2 hours after placement on the water.

One advantage of the embodiments of the invention is that the urns provide a way for the bereaved individual to honor the loved one in a number of different ways. For example, the urns can be ceremonially placed on water or kept for a period of time at a desired location and then later placed on water. As part of a ceremony honoring the deceased, the urns can be placed in the ocean or a lake where the urns and the ashes contained therein are accepted in an environmentally pleasing manner. Alternatively, the urns may be buried in the ground. When so buried in a relatively humid environment, the urn and its contents are degradable over time in an environmentally friendly, non-toxic manner.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. An urn for holding the cremated remains of a deceased human or pet, comprising:
a body portion including an opening, wherein said body portion defines an inner cavity for placement of the remains, said body portion being relatively flat in shape; and
a lid portion for covering the opening, wherein said body portion and said lid portion are composed of rock salt;
wherein the composition of the rock salt allows the urn to float for a minimum of 1 minute upon placement on water and dissolve within several hours upon placement on water.

2. The urn of claim 1, wherein the body portion is circular in shape and has a height to diameter ratio of at most 0.4.

3. The urn of claim 1, wherein said inner cavity has a volume of at least 220 cubic inches.

4. The urn of claim 1, wherein said body portion is one continuous piece of rock salt.

5. The urn of claim 1, wherein said body portion and said lid portion are carved from rock salt using a lathe.

6. The urn of claim 1, wherein a bottom surface of said body portion includes a flat section.

7. The urn of claim 1, wherein the urn is configured to float for a maximum of 5 minutes upon placement on water.

8. The urn of claim 1, wherein the urn is configured to dissolve within the range of 1 to 2 hours upon placement on water.

9. The urn of claim 1, wherein the composition of the rock salt includes 0.037% calcium, 0.001% iron, 0.015% magnesium, 99.09% salt, and 0.857% moisture, wherein the composition of the 99.09% salt includes 39.17% sodium and 59.92% chloride.

10. The urn of claim 1, wherein the lid portion is glued to the body portion, the lid covering the opening.

11. The urn of claim 1, wherein the lid portion defines an inner cavity for placement of a candle, the lid portion including one or more holes.

12. A composition of rock salt for use as a dissolvable urn, the composition comprising: 0.037% calcium, 0.001% iron, 0.015% magnesium, 99.09% salt, and 0.857% moisture, wherein the composition allows the urn to float for a minimum of 1 minute upon placement on water and allows the urn to dissolve within several hours upon placement on water.

13. The composition of claim 12, wherein the composition of the 99.09% salt includes 39.17% sodium and 59.92% chloride.

14. The composition of claim 12, wherein the composition allows the urn to float for a maximum of 5 minutes.

15. The composition of claim 12, wherein the composition allows the urn to dissolve within the range of 1 to 2 hours upon placement on water.

16. A method, comprising:
providing an urn for holding cremated remains, wherein the urn is composed of rock salt and is relatively flat in shape; and
placing the urn on water;
whereby the urn is configured to float upon placement on water for a minimum of 1 minute and dissolve within several hours after placement on water.

17. The method of claim 16, wherein the chemical composition of the rock salt includes 0.037% calcium, 0.001% iron, 0.015% magnesium, 99.09% salt, and 0.857% moisture, wherein the chemical composition of the 99.09% salt includes 39.17% sodium and 59.92% chloride.

18. The method of claim 16, wherein the urn includes a body portion and a lid, said body portion defining an inner cavity for placement of the remains, said body portion having an opening and said lid configured to cover said opening.

19. The method of claim 18, wherein said lid defines an inner cavity for placement of a candle.

20. The method of claim 16, wherein said body portion has a circular cross section, wherein the urn has a height to largest diameter ratio of at most 0.4.
